(19) United States
(12) Patent Application Publication
(10) Pub. No.: US 2018/0279659 A1
(43) Pub. Date: Oct. 4, 2018

(54) BRINE SOLUTIONS

(71) Applicant: Dow Global Technologies LLC, Midland, MI (US)

(72) Inventor: Puspendu Deo, Midland, MI (US)

(21) Appl. No.: 15/764,421

(22) PCT Filed: Sep. 27, 2016
(86) PCT No.: PCT/US16/53888

§ 371 Date: Mar. 29, 2018

Related U.S. Application Data
(60) Provisional application No. 62/235,735, filed on Oct. 1, 2015.

(51) Int. Cl. A23L 13/70; A23L 13/40; A23L 29/262

(52) U.S. Cl. CPC A23L 13/72; A23L 13/422; A23V 2002/00; A23L 29/262; A23L 13/432

(57) ABSTRACT

Provided is a brine solution comprising
(a) water
(b) salts comprising
   (i) sodium chloride and
   (ii) one or more phosphate salts,
(c) one or more methyl cellulose, one or more hydroxypropyl methylcellulose, or a mixture thereof, and
(d) one or more carboxymethyl cellulose,
   wherein (b) is present in an amount of 3% to 20% by weight based on the weight of the brine solution,
   wherein (c) and (d) are present in amounts such that the amount of (c) plus the amount of (d) is 0.2% to 5% based on the weight of the brine solution,
   wherein the amount of (d) is 15% to 30% by weight based on the sum of the weights of (c) and (d).

Also provided is a method for treating meat comprising bringing said meat into contact with such a brine solution.

It is often desired to bring a brine solution into contact with meat. When the brine solution is absorbed into the meat, it is generally thought to improve the juicy feel and the plumpness of the meat as it is eaten after cooking. However, there is a tendency for the injected fluid to drain from the meat during a cooking process. Such fluid loss is undesirable because it causes the meat to shrink, and it causes the meat to seem more dry as it is eaten after cooking.

One approach to retaining the injected fluid during cooking is taught by U.S. Pat. No. 3,073,705, which describes a process in which alkyl ether cellulose is dissolved in brine. At room temperature, the resulting solution has low viscosity and may be injected easily. Then during cooking, the alkyl ether cellulose forms a gel, which acts to prevent shrinkage due to loss of fluid. However, in the course of making the present invention it was noticed that when a brine solution that contains alkyl ether cellulose is heated, not only does a gel form, but the solution also undergoes syneresis. That is, the solution separates into a water-rich, low-viscosity phase and a concentrated gel phase. It is expected that the water-rich phase could easily leave the meat during cooking. It is desired to provide a brine solution that minimizes the amount of syneresis that occurs upon heating. It is also desired to provide a brine solution that, upon heating, forms a gel that has acceptable mechanical strength.

The following is a statement of the invention.

A first aspect of the present invention is a brine solution comprising
(a) water
(b) salts comprising
   (i) sodium chloride and
   (ii) one or more phosphate salts,
(c) one or more methyl cellulose, one or more hydroxypropyl methylcellulose, or a mixture thereof, and
(d) one or more carboxymethyl cellulose,
   wherein (b) is present in an amount of 3% to 20% by weight based on the weight of the brine solution,
   wherein (c) and (d) are present in amounts such that the amount of (c) plus the amount of (d) is 0.2% to 5% based on the weight of the brine solution,
   wherein the amount of (d) is 15% to 30% by weight based on the sum of the weights of (c) and (d).

A second aspect of the present invention is a method for treating meat comprising bringing said meat into contact with the brine solution of the first aspect.

The following is a detailed description of the invention.

As used herein, the following terms have the designated definitions, unless the context clearly indicates otherwise.

As used herein, a brine solution is a composition that is liquid at 23° C., that contains 60% or more water by weight, and that contains 3% or more by weight sodium chloride dissolved in the water.

Cellulose is a naturally occurring organic polymer consisting of linear chain of linked D-glucose units. Cellulose is often reacted with one or more of various reagents to produce various derivatives.

Methylcellulose polymer (MC) is a compound that has repeat units of the structure I:

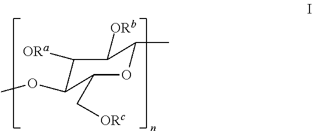

In structure I, the repeat unit is shown within the brackets. The index n is sufficiently large that structure I is a polymer; that is, n is sufficiently large that the “2% solution viscosity” (as defined below) of the compound is 2 mPa*s or higher. In MC, —R^{a}, —R^{b}, and —R^{c} is each independently chosen from —H and —CH₃. The choice of —R^{a}, —R^{b}, and —R^{c} may be the same in each repeat unit, or different repeat units may have different choices of —R^{a}, —R^{b}, and —R^{c}.

Methylcellulose polymer is characterized by the weight percent of methoxyl groups. The weight percentages are based on the total weight of the methylcellulose polymer. By convention, the weight percent is an average weight percentage based on the total weight of the cellulose repeat unit, including all substituents. The content of the methoxyl group is reported based on the mass of the methoxyl group (i.e., —OCH₃). The determination of the % methoxyl in methylcellulose (MC) polymer is carried out according to the United States Pharmacopeia (USP 37, “Methylcellulose”, pages 3776-3778).

Methylcellulose polymer is also characterized by the viscosity of a 2 wt.-% solution in water at 20° C. The 2% by weight methylcellulose polymer solution in water is prepared and tested according to United States Pharmacopeia (USP 37, “Methylcellulose”, pages 3776-3778). As described in the United States Pharmacopeia, viscosities of less than 600 mPa·s are determined by Ubbelohde viscosity measurement and viscosities of 600 mPa·s or more are determined using a Brookfield viscometer. When the 2 wt-% solution of MC has been made, the correct viscometer chosen, and the viscosity measured, the resulting measured viscosity is known herein as the “2% solution viscosity.”

Hydroxypropyl methylcellulose polymer (HPMC) has the structure I, where —R^{a}, —R^{b}, and —R^{c} is each independently chosen from —H, —CH₃, and structure II:

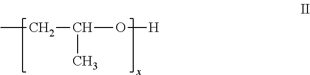

The choice of —R^{a}, —R^{b}, and —R^{c} may be the same in each repeat unit, or different repeat units may have different choices of —R^{a}, —R^{b}, and —R^{c}. The number x is an integer of value 1 or larger. One or more of —R^{a}, —R^{b}, and —R^{c} has structure II on one or more of the repeat units.

Hydroxypropyl methylcellulose polymer (HPMC) is characterized by the weight percent of methoxyl groups. The weight percentages are based on the total weight of the hydroxypropyl methylcellulose polymer. By convention, the weight percent is an average weight percentage based on the total weight of the cellulose repeat unit, including all substituents. The content of the methoxyl group is reported based on the mass of the methoxyl group (i.e., —OCH₃). The determination of the % methoxyl in hydroxypropyl methylcellulose polymer is carried out according to the United States Pharmacopeia (USP 37, “Hypromellose”, pages 3296-3298).

Hydroxypropyl methylcellulose polymer is characterized by the weight percent of hydroxypropyl groups. The weight percentages are based on the total weight of the hydroxypropyl methylcellulose polymer. The content of the hydroxypropoxyl group is reported based on the mass of the hydroxypropoxyl group (i.e., —O—C₃H₆OH). The determination of the % hydroxypropoxyl in hydroxypropyl methylcellulose (HPMC) is carried out according to the United States Pharmacopeia (USP 37, “Hypromellose”, pages 3296-3298).

Hydroxypropylmethylcellulose polymer is also characterized by the viscosity of a 2 wt. % solution in water at 20° C. The 2% by weight hydroxypropylmethylcellulose polymer solution in water is prepared and tested according to United States Pharmacopeia (USP 37, “Hypromellose”, pages 3296-3298). As described in the United States Pharmacopeia, viscosities of less than 600 mPa·s are determined by Ubbelohde viscosity measurement and viscosities of 600 mPa·s or more are determined using a Brookfield viscometer. This viscosity is known herein as the “2% solution viscosity.”

It is useful to consider all of the MC present in the composition together with al. of the HPMC. Together, these materials are referred to herein as ingredient (d).

Carboxymethyl cellulose (CMC) has structure I in which —R^{a}, —R^{b}, and —R^{c} is each independently chosen from —H and —CH₂COOH. The choice of —R^{a}, —R^{b}, and —R^{c} may be the same in each repeat unit, or different repeat units may have different choices of —R^{a}, —R^{b}, and —R^{c}. The average number of groups per D-glucose unit in which —R^{a}, —R^{b}, or —R^{c} is —H (denoted “x”) is 1.5 to 2.8. The average number of groups per D-glucose unit in which —R^{a}, —R^{b}, or —R^{c} is —CH₂COOH (denoted “y” or “degree of substitution”) is 0.2 to 1.5. In CMC, x+y is 3.0 The degree of substitution is determined according to ASTM D 1439-03 “Standard Test Methods for Sodium Carboxymethylcellulose; Degree of Etherification, Test Method B: Nonaqueous Titration” (American Society for Testing and Materials, Conshohocken, Pa., USA). CMC is characterized by the viscosity (Brookfield LVT, SP at 30 rpm at 25° C.) of a 1% solution by weight in water.

The term carboxymethyl cellulose polymer (CMC) is considered to include both the neutral form of the compound and forms in which some or all of the carboxyl groups are in the anionic form.

As used herein, the term “phosphate anion” refers to any anion selected from orthophosphate, the polyphosphates, the metaphosphates, the ultraphosphates, and hydrated versions thereof. The term “phosphate anion” is considered herein to include all stages of partial or full neutralization of the acid form. As an illustrative example, PO₄⁻³, HPO₄⁻², and H₂PO₄⁻¹ are all considered phosphate anions. As used herein, the term “phosphate salt” refers to any salt that contains a cation and a phosphate anion, including all stages of partial neutralization, full neutralization, and the acid form, and hydrated versions thereof.

As used herein, a gel is a colloidal or polymer network that is expanded throughout its volume by water. A does not flow the way a fluid flows; a gel tends to retain its shape under the force of gravity.

Meat is animal flesh that is suitable to be eaten as food. Meat includes skeletal muscle and other edible tissues. Meat includes the flesh of mammals, birds, reptiles, and fish. Meat may be in the form of the animal tissue that has been only cut into relatively large pieces without further processing other than storage, or the meat may processed in some way, including, for example, curing, smoking, grinding, addition of flavorings, or a combination thereof. As used herein, the term “meat” includes meat products that result from processing the meat.

The present invention involves a brine solution. The amount of sodium chloride in the brine solution is, by weight based on the weight of the solution, 3% or more; preferably 4% or more; more preferably 5% or more; more preferably 6% or more. The amount of sodium chloride in the brine solution is, by weight based on the weight of the solution, 20% or less; more preferably 17% or less; more preferably 14% or less; more preferably 12% or less; more preferably 10% or less.

The brine solution additionally contains one or more phosphate salt. Preferred phosphate salts are partially or fully neutralized salts of the corresponding acids. Preferred phosphate salts contain one or more metaphosphate anion; one or more monobasic phosphate anion, one or more tribasic phosphate anion, hydrated versions thereof, and mixtures thereof. Among partially or fully neutralized phosphate salts, the preferred cation is one or more alkali metal; more preferably sodium. Preferably the amount of phosphate salt in the brine solution is, by weight based on the weight of the brine solution, 0.1% or more; more preferably 0.2% or more; more preferably 0.4% or more; more preferably 0.8% or more. Preferably the amount of phosphate salt is, by weight based on the weight of the brine solution, 8% or less; more preferably 6% or less; more preferably 4% or less; more preferably 2.5% or less. The phrase “the amount of phosphate salt” refers to the total amount of all phosphate salts. If hydrated salt is dissolved in water, the concentration of that salt in the resulting solution is considered to be the weight of the non-hydrated form of the salt, as a percentage of the total weight of the solution.

Among MC polymers, preferably the % methoxyl is 15% or higher; more preferably 25% or higher. Among MC polymers, preferably the % methoxyl is 40% or lower; more preferably 35% or lower. Among MC polymers, preferably the viscosity of a 2 weight % solution in water is preferably 70 mPa*s or higher; more preferably 200 mPa*s or higher; more preferably 1,000 mPa*s or higher; more preferably 2,500 mPa*s or higher. Among MC polymers, preferably the viscosity of a 2 weight % solution in water is preferably 50,000 mPa*s or lower; more preferably 25,000 mPa*s or lower; more preferably 8,000 mPa*s or lower.

Among HPMC polymers, preferably the % methoxyl is 10% or higher; more preferably 18% or higher. Among HPMC polymers, preferably the % methoxyl is 30% or lower; more preferably 26% or lower. Among HPMC polymers, preferably the % hydroxypropyl is 4% or higher; more preferably 6% or higher. Among HPMC polymers, preferably the % hydroxypropyl is 20% or lower; more preferably 15% or lower.

Among HPMC polymers, the viscosity of a 2 weight % solution in water is preferably 70 mPa*s or higher; more preferably 200 mPa*s or higher; more preferably 1,000 mPa*s or higher; more preferably 2,500 mPa*s or higher. Among HPMC polymers, the viscosity of a 2 weight % solution in water is preferably 50,000 mPa*s or lower; more preferably 25,000 mPa*s or lower; more preferably 8,000 mPa*s or lower. Preferably, when HPMC polymer is used that has viscosity of a 2 weight % solution in water of 2,000 mPa*s or higher, the amount of HPMC polymer, by weight based on the weight of the composition, is 2% or lower.

In the brine solution, the amount of MC plus the amount of HPMC is referred to herein as “the amount of (c).” The following embodiments are envisioned: embodiments in which the brine solution contains one or more MC and contains no HPMC; embodiments in which the brine solution contains no MC and contains one or more HPMC; and embodiments in which the brine solution contains one or more MC and also contains one or more HPMC.

Among CMC polymers, preferably the degree of substitution is 0.95 or lower. Preferably the degree of substitution of CMC is 0.75 or higher, more preferably 0.8 or higher. Preferably, the viscosity of CMC solution (1% by weight in water at 25° C.) is 200 mPa*s or higher; more preferably 400 mPa*s or higher; more preferably 800 mPa*s or higher. Preferably, the viscosity of CMC solution (1% by weight in water at 25° C.) is 3000 mPa*s or lower; more preferably 2500 mPa*s or lower.

In the brine solution, the amount of MC plus the amount of HPMC plus the amount of CMC is referred to herein as “the amount of (c) plus (d).” The amount of (c) plus (d) is, by weight based on the weight of the brine solution, 0.2% or more; preferably 0.4% or more; more preferably 0.6% or more; more preferably 0.8% or more. The amount of (c) plus (d) is, by weight based on the weight of the brine solution, 5% or less; preferably 4% or less; more preferably 3% or less; more preferably 2% or less.

In the brine solution, the amount of CMC is, by weight based on the weight of the amount of (c) plus (d), 15% or more; preferably 16% or more; more preferably 17% or more. In the brine solution, the amount of CMC is, by weight based on the weight of the amount of (c) plus (d), 30% or less; preferably 28% or less; more preferably 26% or less; more preferably 24% or less.

Preferably, the brine solution contains no cellulose or cellulose derivative other than CMC, MC, and HPMC. Preferably, the brine solution contains no polymer other than CMC, MC, and HPMC. For materials that are not cellulose or cellulose derivatives, a “polymer,” as used herein, is a relatively large molecule that is made up of the reaction products of smaller chemical repeat units and that has molecular weight of 1,000 or more.

Preferably, the amount of water in the brine solution is, by weight based on the weight of the brine solution, 97% or less; more preferably 95% or less; more preferably 93% or less; more preferably 91% or less. Preferably, the amount of water in the brine solution is, by weight based on the weight of the brine solution, 70% or more; more preferably 75% or more; more preferably 80% or more; more preferably 85% or more.

In some embodiments, the brine solution optionally contains one or more ingredients in addition to (a), (b), (c), (d), and phosphate salts. Preferred additional ingredients include sugars, nitrates, nitrites, ascorbates, seasonings, flavorings, and combinations thereof.

A preferred use for the brine solution is bring the brine solution into contact with meat. Preferred methods of bringing the brine solution into contact with meat are marinating, spraying, and injection. Marinating involves placing the meat and the brine solution into a container so that some or all of the surface of the meat is covered by liquid brine solution when the meat and the marinade are at rest. Spraying involves forcing the brine solution through nozzles to produce a moving stream of brine solution or of droplets of brine solution; the moving stream impacts the surface of the meat. Injection (also called pumping) involves penetrating the meat with one or more needles, then forcing brine solution through the needle and out of one or more holes in each needle into the interior of the meat. Preferred is injection.

After the meat has been brought into contact with brine solution, when the meat is subsequently cooked, preferably the brine solution in the interior or the meat does not undergo syneresis. It is considered that syneresis leads to loss of water from the meat, because the water-rich phase formed during syneresis has relatively low viscosity and can readily drain from the meat. It is also desired that when the meat is cooked, that the brine solution in the meat forms a gel.

The tendency of the brine solution to undergo syneresis and the ability of the brine solution to form a gel may be studied by examining the behavior or the brine solution in laboratory tests. It is considered that the behavior of the brine solution in meat will reflect the behavior of the brine solution in the laboratory tests.

The following are examples of the present invention.

The same brine solution was used in all of the examples described below. That brine solution contained dissolved NaCl of concentration between 7% and 10% by weight, and various dissolved sodium phosphates of concentration between 1% and 4% by weight. The brine solution was prepared by mixing water, NaCl salt, and a mixture of sodium phosphate salts. The mixture of sodium phosphate salts was made of a mixture of sodium phosphate monobasic monohydrate, sodium hexametaphosphate, and sodium phosphate tribasic dodecahydrate.

The brine solution was prepared by first adding all the salts to the water at room temperature (approximately 23° C.). After the salt was dissolved, the required concentration of cellulose derivative (or mixture of cellulose derivatives) was added to the salt solution with continuous mixing. After the cellulose derivative(s) dispersed well, the solution temperature was decreased to 3 to 5° C. The solution was mixed for 10 minutes at 3 to 5° C.

Gel strength and syneresis were measured as follows.

The cylindrically-shaped gel was prepared by placing 80 g of an brine solution as prepared above in a metal beaker and covering the beaker with a foil. The beaker was then placed in a pan of boiling water for 15 minutes, at which point a gel formed. The excess liquid that was expulsed from the gel by syneresis was drained out of the beaker, and then the cylindrically-shaped gel was placed onto three paper towels and tested. The gel puncture force was measured with a Texture Analyzer (model TA.XT2 from Stable Micro Systems, 5-kg load cell) with a 45° conical probe moving at 2 mm/s and at a distance of 15 mm into a cylindrically-shaped gel (height=35 mm, diameter=45 mm). Tests were done in triplicate per solution, and average values were reported. The cylindrically-shaped gels were tested at 80° C. The average forces are measure of the force that is needed to penetrate the gel. The syneresised water from the gel was transferred to a weighing boat for the calculation of syneresis percentage. Gel strength is reported as force (N), and syneresis is reported as the weight of the expulsed water, expressed as a percentage based on the original weight of the brine solution.

The following materials were used:
CMC=carboxymethyl cellulose, 0.9 degree of substitution, viscosity of 1% solution in water at 30 rpm between 1900 and 2600 mPa*s.
MC=methylcellulose, 2% viscosity between 2660 and 4970 mPa*s; % methoxyl between 27.5% and 31.5%.
HPMC1=hydroxypropyl methylcellulose, 2% viscosity between 2660 and 4,970 mPa*s; % methoxyl between 19 and 24%; and % hydroxypropyl between 7 and 12%
HPMC2=hydroxypropyl methylcellulose, 2% viscosity between 2660 and 4,970 mPa*s; % methoxyl between 19 and 24%; and % hydroxypropyl between 7 and 12%. HPMC2 has a higher gel temperature than HPMC1.

The following results were obtained. Each example was a solution containing brine and one or more cellulose derivative, prepared as described above. “Ex.” means “example.” Examples with suffix “C” are comparative. Amounts shown are weight percent based on the weight of the brine solution. Viscosity was measured at approximately 23° C. using a Brookfield LV model DV-II+ at 5 rpm. “nt” means not tested.

| | | | | | | Gel | |
|---|---|---|---|---|---|---|---|
| | % | % | % | % | Viscosity | Strength | Syneresis |
| Ex. | CMC | MC | HPMC1 | HPMC2 | (mPa*s) | (N) | (%) |
| 1C | 0 | 1 | 0 | 0 | nt | 2.1 | 56 |
| 2C | 0 | 0.8 | 0 | 0 | nt | 1.0 | 44 |
| 3C | 0.1 | 0.9 | 0 | 0 | nt | 1.2 | 47 |
| 4 | 0.2 | 0.8 | 0 | 0 | 1512 | 0.9 | 9.8 |
| 5C | 0.4 | 0.6 | 0 | 0 | nt | 0.45 | 39 |
| 6C | 0 | 0 | 1 | 0 | nt | 0.78 | 49 |
| 7C | 0 | 0 | 0 | 1 | nt | note⁽¹⁾ | 25 |
| 8 | 0.2 | 0.4 | 0.4 | 0 | 1218 | 0.97 | 11.2 |
| 9 | 0.2 | 0.4 | 0 | 0.4 | 1326 | 0.55 | 8 |

Note⁽¹⁾:
gel too weak to measure.

All of the comparative examples had syneresis that was relatively high (25% or higher), while all of the inventive examples had syneresis that was relatively low (below 12%). Thus the inventive examples showed desirably less syneresis than the comparative samples. Also, all of the inventive examples had gel strength that was acceptably high.

1. A brine solution comprising
(a) water
(b) salts comprising
(i) sodium chloride and
(ii) one or more phosphate salts,
(c) one or more methyl cellulose polymer, one or more hydroxypropyl methylcellulose polymer, or a mixture thereof, and
(d) one or more carboxymethyl cellulose polymer,
wherein (b) is present in an amount of 3% to 20% by weight based on the weight of the brine solution,
wherein (c) and (d) are present in amounts such that the amount of (c) plus the amount of (d) is 0.2% to 5% based on the weight of the brine solution,
wherein the amount of (d) is 15% to 30% by weight based on the sum of the weights of (c) and (d).

2. The brine solution of claim 1, wherein said brine solution additionally comprises one or more phosphate salt.

3. The brine solution of claim 1, wherein said methylcellulose polymer has viscosity of a 2 weight % solution in water at 20° C. of 70 mPa*s to 25,000 mPa*s.

4. The brine solution of claim 1, wherein said hydroxypropyl methylcellulose polymer has viscosity of a 2 weight % solution in water at 20° C. of 70 mPa*s to 25,000 mPa*s.

5. The brine solution of claim 1, wherein said carboxymethylcellulose polymer has viscosity of a 1 weight % solution in water at 25° C. of 200 mPa*s to 2,500 mPa*s.

6. A method for treating meat comprising bringing said meat into contact with the brine solution of claim 1.

7. The method of claim 6, wherein said step of bringing said meat into contact with the brine solution of claim 1 comprises injecting said brine solution into the interior of said meat through one or more needles.
